(19) United States
(12) Patent Application Publication
(10) Pub. No.: US 2026/0159038 A1
(43) Pub. Date: Jun. 11, 2026

(54) VEHICLE WIPER DEVICE

(71) Applicant: DENSO CORPORATION, Kariya-city (JP)

(72) Inventor: Yuji MATSUMOTO, Kariya-city (JP)

(73) Assignee: DENSO CORPORATION, Kariya-city (JP)

(21) Appl. No.: 19/388,257

(22) Filed: Nov. 13, 2025

(30) Foreign Application Priority Data
Dec. 9, 2024 (JP) 2024-214460

(51) Int. Cl. B60S 1/34

(52) U.S. Cl. CPC B60S 1/3409; B60S 1/3431

(57) ABSTRACT

A vehicle wiper device includes a position changing mechanism capable of adjusting circumferential and radial positions of a follower shaft relative to a drive shaft. The wiper arm comprises a main arm and a sub-arm, which are connected to a wiper blade via a link mechanism. The drive shaft operates to move the main arm, while the follower shaft mechanically supports the sub-arm. This structure allows the positional relationship between the follower shaft and the drive shaft within the link mechanism to be adjusted without the need for any additional mechanism. Consequently, the same wiper device can be used for a variety of different vehicle models.

### CROSS REFERENCE TO RELATED DOCUMENT

The present application claims the benefit of priority of Japanese Patent Application No. 2024-214460 filed on Dec. 9, 2024, the disclosure of which is incorporated in its entirety herein by reference.

### TECHNICAL FIELD

This disclosure relates generally to a vehicle wiper device.

### BACKGROUND ART

Japanese Patent First Publication No. 2018-188138 discloses a vehicle wiper device having installed therein a link mechanism which is capable of wiping an area beyond a typical arc-shaped area to be wiped. Such a type of vehicle wiper device is capable of adjusting the operation of the link mechanism to be compatible with the wiping surface which typically differs depending on each vehicle model

There is a known system that changes a relationship between a driving link and a driven link installed in the link mechanism, in other words, a positional relation of a driven shaft to a drive shaft in order to modify or adjust the geometry of an area to be swept by the wiper. The wiper device, as taught in the above publication, in which a combination of the drive shaft and the driven shaft is to be customized for each vehicle model, requires redesign in order to reset the positions of the drive and driven shafts whenever the vehicle model is changed.

### SUMMARY

It is an object of the present disclosure to provide a vehicle wiper device which is capable of changing a positional relationship of a driven shaft relative to a drive shaft of a link mechanism, thereby allowing the vehicle wiper device to be shared among a plurality of vehicle models.

According to one aspect of this disclosure, there is provided a vehicle wiper device which comprises: (a) a link mechanism which is configured to cause a wiper to perform a composite wiping operation including a combination of a basic arcuate motion and an additional motion; and (b) a position changing mechanism. The link mechanism includes a drive member and a follower member. The drive member is coupled with a drive shaft which is driven in response to actuation of a wiper motor. The follower member is supported by a follower shaft positioned relative to the drive shaft and configured to follow movement of the drive member. The follower shaft is coupled with a shaft support member which is secured to a mounting member used to mount the vehicle wiper device to a vehicle body. The position changing mechanism is capable of changing at least one of a circumferential position and a radial position of the follower shaft relative to the drive shaft.

According to the above configuration, the drive member and the follower member of the link mechanism, which is configured to cause the wiper to perform a composite wiping operation, are capable of changing at least one of the circumferential position and the radial position of the follower shaft relative to the drive shaft by means of the position changing mechanism of the vehicle wiper device. This configuration enables the position(s) of the follower shaft to be adjusted using the same device, thereby allowing a wiping area shape of different wipers to be set as desired. Accordingly, the same device can be commonly used for a plurality of vehicle models.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a schematic view which illustrates a vehicle wiper device according to the first embodiment;

FIG. 2 is a perspective view which illustrates a wiper drive device according to the first embodiment;

FIG. 3 is a partial perspective view which illustrates a mounting bracket used to mount a vehicle wiper device to a vehicle body according to the first embodiment;

FIG. 4 is a partial sectional view which shows a mounting mode between a mounting bracket and a shaft support plate of a vehicle wiper device according to the first embodiment;

FIG. 5 is a schematic view which illustrates a vehicle wiper device mounted on a vehicle according to the second embodiment;

FIG. 6 is a perspective view which illustrates a wiper drive device according to the second embodiment; and

FIG. 7 is a schematic view which illustrates a vehicle wiper device according to the third embodiment.

### MODES FOR CARRYING OUT THE INVENTION

### First Embodiment

A vehicle wiper device according to the first embodiment will be described below.

### Vehicle Wiper Device 10

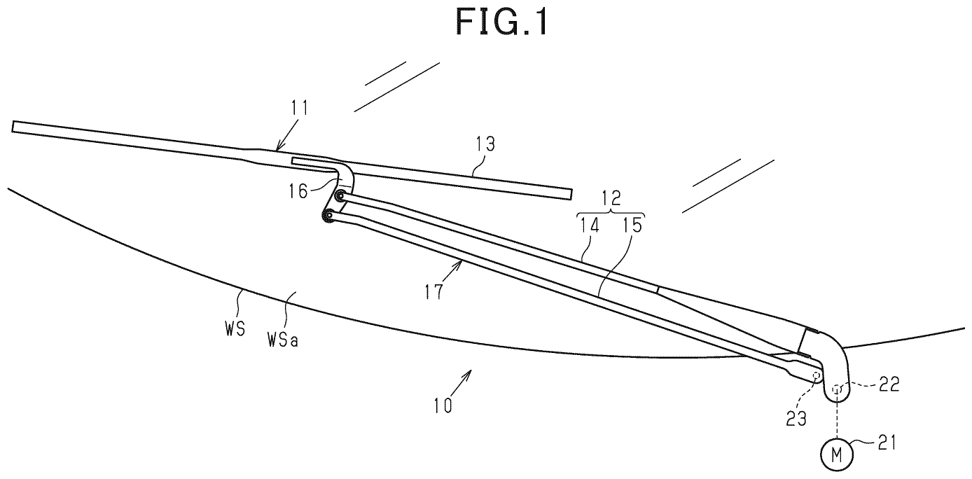

The vehicle wiper device 10 in this embodiment is, as illustrated in FIG. 1, configured to wipe away raindrops or other deposits adhered onto the surface WSa of the front windshield WS of a vehicle, for example. The vehicle wiper device 10 includes the wiper 11 that performs a reciprocating wiping operation on the surface WSa, and the wiper drive device 21 that drives the reciprocating wiping operation of the wiper 11.

### Wiper 11

In this embodiment, the wiper 11 includes the wiper arm 12 that reciprocally swings about its base end, and the wiper blade 13 that is connected to the tip end of the wiper arm 12.

The wiper arm 12 includes the main arm 14, a base end of which is directly connected to the drive shaft 22 of the wiper drive device 21, and the sub arm 15, a base end of which is directly connected to the follower shaft 23 integrally provided on the wiper drive device 21. The wiper arm 12 further includes the tip connecting member 16 that rotatably connects the tip portions of the main arm 14 and the sub arm 15 to each other. The main arm 14, the sub arm 15, and the tip connecting member 16 are configured as the link mechanism 17 having respective connection shafts extending along a direction substantially perpendicular to the surface WSa. The tip connecting member 16 is connected to the wiper blade 13. The wiper blade 13 is arranged such that a blade rubber (not shown) thereof is in contact with the surface WSa.

When the main arm 14 of the wiper arm 12 is driven, the link mechanism 17 causes the wiper blade 13 to slant or tilt relative to the wiper arm 12 within a predetermined angular range in association with the reciprocating swinging motion of the main arm 14. As a result, the wiper blade 13 performs a composite wiping operation on the surface WSa by combining a basic arcuate motion with an additional tilting motion that increases toward the end of the arcuate motion. In other words, the combination of the tilting motion and the basic arcuate motion of the wiper blade 13 enables the shape of the wiping area of the wiper blade 13 to match the shape of the surface WSa for each vehicle type, such as by enlarging the wiping area by positioning the reversing position of the reciprocating wiping operation as close as possible to the edge of the surface WSa.

### Wiper Drive Device 21

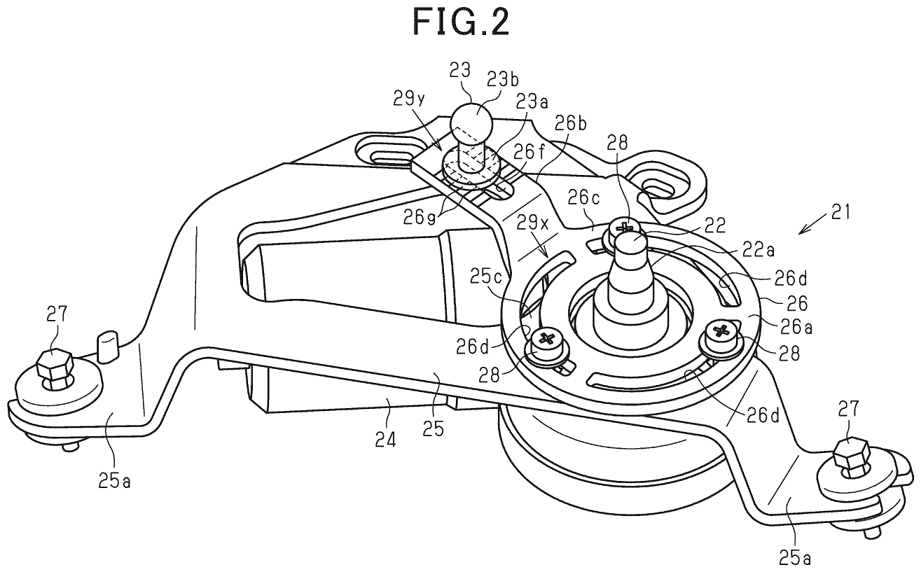

The wiper drive device 21 of this embodiment, as illustrated in FIG. 2, includes the electric wiper motor 24 having the drive shaft 22 for directly driving the main arm 14 of the wiper arm 12. The tip portion of the drive shaft 22 protruding from the wiper motor 24 is provided with the mounting portion 22a for firmly securing the base end of the main arm 14. The wiper motor 24 works to reciprocally rotate the drive shaft 22, thereby reciprocally swinging the main arm 14. The wiper drive device 21 further includes the mounting bracket 25 used as a mounting or fastening member to fasten the wiper drive device 21 to the vehicle body (not shown), and the shaft support plate 26 used as a shaft support member having the follower shaft 23 for supporting the sub arm 15.

### Mounting Bracket 25

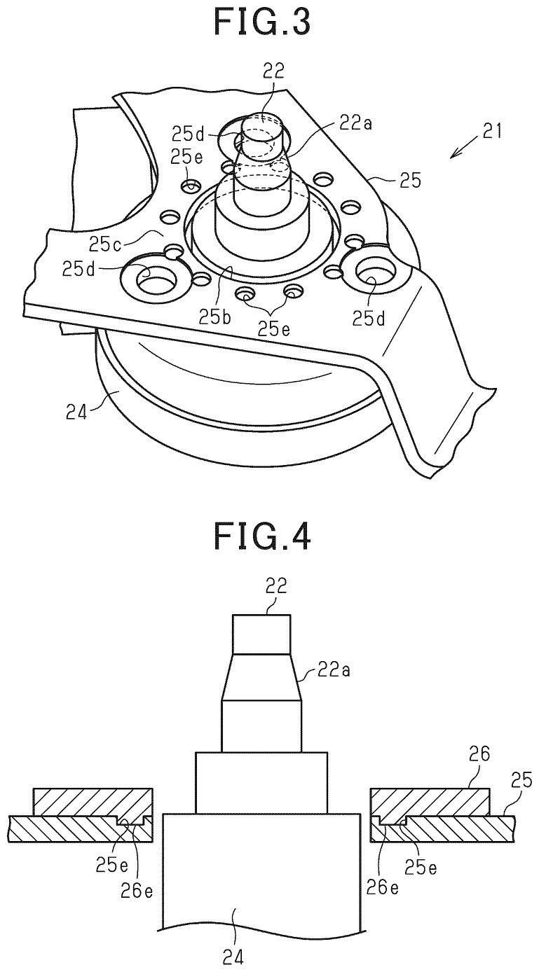

The mounting bracket 25, as shown in FIGS. 2 and 3, is formed from a plate-shaped material and includes a plurality of vehicle body mounting portions 25a, which are used to attach the bracket to the vehicle body using the bolts 27. The mounting bracket 25 further has the opening 25b and the mounting portion 25c, which are located inside and surrounded by the vehicle body mounting portions 25a. The wiper motor 24 is arranged beneath the lower surface of the mounting portion 25c and is secured to it so that the drive shaft 22 protrudes upward through the opening 25b, which is formed at the center of the mounting portion 25c.

The mounting portion 25c is arranged coaxially with the drive shaft 22 around the opening 25b from which the drive shaft 22 protrudes. The mounting portion 25c has formed therein, for example, three screw holes 25d located at equal angular intervals away from each other on a circle defined coaxially with the drive shaft 22. The mounting portion 25c also has twelve recesses 25e arranged at equal angular intervals away from each other on a circle defined coaxially with the drive shaft 22 inside the screw holes 25d. The recesses 25e are identical in shape to each other and have, for example, a circular cross-sectional shape.

### Shaft Support Plate 26

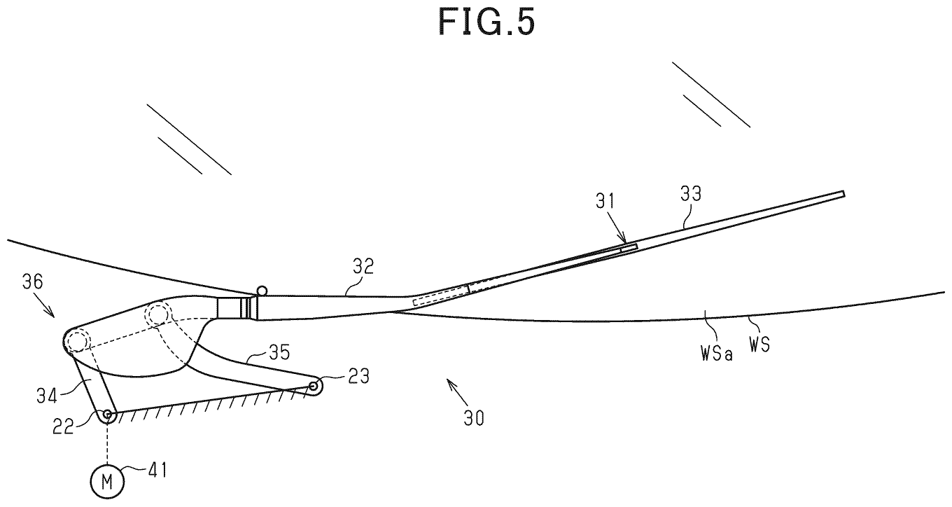

The shaft support plate 26 is, as illustrated in FIGS. 2 and 4, formed from a metal plate-shaped material and includes the annular portion 26a and the extension portion 26b extending radially outward from the annular portion 26a. The annular portion 26a includes the mounting portion 26c facing the mounting portion 25c of the mounting bracket 25. The mounting portion 26c has formed therein three elongated holes 26d arranged on the same circle as that which is defined coaxially with the drive shaft 22 and along which the screw holes 25d of the mounting bracket 25 are located when the mounting portion 26c is secured to the mounting bracket 25. The elongated holes 26d are identical in shape to each other and each have an arcuate shape along the above concentric or coaxial circle over a range of approximately 120°. When the shaft support plate 26 is fixed to the mounting bracket 25, the mounting screws 28 are inserted through the elongated holes 26d and tightened into the screw holes 25d.

The mounting portion 26c also has the projections 26e arranged on the same coaxial circle on which the recesses 25e are located. For example, the protrusions 26e are disposed at equal angular intervals away from each other. The number of the protrusions 26e is three, while the number of the recesses 25e is twelve. The protrusions 26e are identical in shape to each other and each has a cylindrical shape that is fittable into the recess 25e. The shaft support plate 26 is designed to have a changeable position where the shaft support plate 26 is secured to the mounting portion 25c of the mounting bracket 25.

The extension portion 26b has the elongated hole 26f extending in the radial direction of the drive shaft 22, that is, the length direction of the extension portion 26b in a state where the extension portion 26b is attached to the mounting bracket 25. The follower shaft 23 is attached to the elongated hole 26f. The follower shaft 23 has the flange 23a at an intermediate portion thereof and the spherical portion 23b at a distal end thereof. The attachment of the follower shaft 23 t the extension portion 26b is achieved by bringing the flange 23a into contact with an upper surface of the extension portion 26b and then tightening a nut (not shown) onto an external thread formed on a base end portion of the follower shaft 23 inserted through the elongated hole 26f. The follower shaft 23 is mounted so as to grip the extension portion 26b between the flange portion 23a and the nut in the thickness direction of the extension portion 26b. The extension portion 26b has a plurality of uneven portions 26g (i.e., convex and concave portions) which are formed in the shape of notches or ridges in or on an upper surface thereof around the peripheral edge of the elongated hole 26f. The uneven portions 26g are arranged adjacent to each other in the length direction of the extension portion 26b. The uneven portions 26g are engageable with uneven portions (e.g., ridges or notches not shown) provided on or in a lower surface of the flange 23a of the follower shaft 23 to define a plurality of detent positions. The follower shaft 23 is shaped to have a position where the follower shaft 23 is firmly secured to the extension portion 26b and which is changeable along the elongated hole 26f of the extension portion 26b.

The base end of the sub arm 15 of the wiper arm 12 is, as clearly illustrated in FIGS. 1 and 2, connected to the distal end of the follower shaft 23. The sub arm 15 connected to the spherical portion 23b at the distal end of the follower shaft 23 is supported in a state in which the sub arm 15 is permitted to tilt in the vertical direction along with rotation about the axis of the follower shaft 23. In other words, since the surface WSa to be wiped by the wiper 11 has a three-dimensional curved shape, this supporting structure is necessary to allow the sub arm 15 to follow the operation of the main arm 14.

### Operation of this Embodiment

The operation of this embodiment will be described below.

The vehicle wiper device 10 also includes the position changing mechanism 29x including the elongated holes 26d. The position changing mechanism 29x is capable of changing the position of the follower shaft 23 in the circumferential direction of the drive shaft 22 by the position (which will also be referred to below as a mounting position), as defined in the circumferential direction of the drive shaft 22, where the shaft support plate 26 is secured to the mounting bracket 25.

The mounting position of the shaft support plate 26 in the circumferential direction of the drive shaft 22 is adjustable to twelve different positions, as shown in FIGS. 2 to 4. These positions are defined at angular intervals of 30° circumferentially around the drive shaft 22, depending on the engagement relationship between the projections 26e and the recesses 25e of the mounting bracket 25. The fastening of the mounting screws 28 into the screw holes 25d through the elongated holes 26d is achievable in any mounting position of the shaft support plate 26. The attachment of the shaft support plate 26 to the mounting bracket 25 is achieved by placing the shaft support plate 26 in one of the mounting positions, as selected for each vehicle model, fitting the protrusions 26e in the corresponding recesses 25e, and then fastening the mounting screws 28 into the screw holes 25d through the elongated holes 26d. Such attachment of the shaft support plate 26 is firmly established by the engagement of the protrusions 26e with the recesses 25e.

The mounting screws 28 may alternatively be fastened to the wiper motor 24 through the elongated holes 26d and the screw holes 25d; that is, they are tightened into screw holes formed in the gear housing of the wiper motor 24. In this configuration, the mounting screws 28 serve not only to attach the shaft support plate 26 to the mounting bracket 25, but also to secure the wiper motor 24 to the mounting bracket 25.

In addition, the position of the follower shaft 23 in the radial direction of the drive shaft 22 (which will also be referred to below as a radial position) may be changeable by means of the position changing mechanism 29y designed to adjust the mounting position of the follower shaft 23 to the extension portion 26b of the shaft support plate 26 using the elongated hole 26f.

As illustrated in FIG. 2, the radial position of the follower shaft 23 may be changed among a plurality of detent positions defined adjacent to each other along the elongated hole 26f of the extension portion 26b. The detent positions correspond to the engagement of the follower shaft 23 with the uneven portions 26g (e.g., notches or ridges) formed along the elongated hole 26f. The attachment of the follower shaft 23 to the extension portion 26b is accomplished placing the follower shaft 23 in one of the detent positions, as selected according to each vehicle model, so that it engages with the uneven portions 26g. The extension portion 26b is them firmly held between the flange 23a and nuts not shown. This attachment of the follower shaft 23 is securely established by the engagement with the uneven portions 26g.

By employing the shaft support plate 26 in the manner described above, both the radial and circumferential positions of the follower shaft 23 relative to the drive shaft 22 can be adjusted, thereby allowing the shape of the wiping area of the wiper 11 to be easily modified. This makes it possible to set the wiping area of the wiper 11 to a shape that is better suited to the surface WSa of each vehicle type.

### Beneficial Advantages Offered by this Embodiment

Beneficial advantages provided by the above embodiment will be described below.

1-1

The vehicle wiper device 10 according to the above-described embodiment includes the link mechanism 17 that causes the wiper 11 to perform the composite wiping operation. The link mechanism 17 includes a drive member and a follower member, which are implemented by the main arm 14 and the sub arm 15 of the wiper arm 12, respectively. The drive shaft 22 functions to drive or move the main arm 14, while the follower shaft 23 functions to support the sub arm 15. The circumferential and radial positions of the follower shaft 23 relative to the drive shaft 22 can be changed by the position changing mechanism 29x or 29y of the vehicle wiper device 10. In other words, both the circumferential and radial positions of the follower shaft 23 are adjustable using the same mechanism, thereby allowing different wiping area shapes of the wiper 11 to be set with high accuracy. Accordingly, the same mechanism can be commonly used for multiple vehicle types.

1-2

The position changing mechanism 29x is constituted by the mounting structure between the shaft support plate 26, which carries the follower shaft 23, and the mounting bracket 25 fixed to the vehicle body. By changing the mounting position of the shaft support plate 26 relative to the mounting bracket 25, the circumferential position of the follower shaft 23 with respect to the drive shaft 22 can be easily adjusted.

1-3

The position changing mechanism 29y is constituted by the mounting structure between the follower shaft 23 and the shaft support plate 26. By changing the mounting position of the follower shaft 23 relative to the shaft support plate 26, the radial position of the follower shaft 23 with respect to the drive shaft 22 can be easily adjusted.

1-4

Between the shaft support plate 26 and the mounting bracket 25, the protrusions 26e and the recesses 25e are provided as interlocking portions that function as a detent mechanism and firmly engage, or in other words, fit with each other. By engaging each of the protrusions 26e with a respective one of the recesses 25e, the shaft support plate 26 is fixed at a selected one of the positions, as defined by combinations of the protrusions 26e and the recesses 25e, relative to the mounting bracket 25, thereby achieving a firm 5 joint of the shaft support plate 26 and the mounting bracket 25, which prevents positional displacement therebetween, thereby enhancing the load-bearing capacity of the follower shaft 23.

1-5

Between the follower shaft 23 and the shaft support plate 26, the uneven portions 26g are provided as interlocking portions which function as a detent mechanism to achieve firm mechanical engagement of the follower shaft 23 and the shaft support plate 26. The detent mechanism works to position the follower shaft 23 by means of the engagement of the follower shaft 23 and the shaft support plate 26 using the uneven portions 26g and also to achieve firm attachment of the follower shaft 23 to the shaft support plate 26 which avoids misalignment of the follower shaft 23 with the shaft support plate 26, thereby enhancing the load-bearing capacity of the follower shaft 23.

The shaft support plate 26 has formed therein the elongated holes 26d, which allow the shaft support plate 26 to be mounted to the mounting bracket 25 at arbitrary positions. The use of the elongated holes 26d makes it easy to realize a configuration in which the mounting position of the shaft support plate 26 can be changed without making the shaft support plate 26 excessively complicated in shape.

The shaft support plate 26 includes the elongated hole 26f, which allows the follower shaft 23 to be mounted at arbitrary positions. The use of the elongated hole 26f makes it easy to realize a configuration in which the mounting position of the follower shaft 23 can be changed without making the shaft support plate 26 excessively complicated in shape.

### Second Embodiment

The second embodiment will be described below with reference to FIG. 5.

### Vehicle Wiper Device 30

The vehicle wiper device 30 according to the second embodiment is, as illustrated in FIG. 5, configured, for example, to wipe off substances such as raindrops that have adhered to the wiping surface WSa of the front windshield WS of the vehicle. The vehicle wiper device 30 includes the wiper 31, which performs a reciprocating wiping operation over the wiping surface WSa, and the wiper drive device 41, which drives the reciprocating movement of the wiper 31.

### Wiper 31

The wiper 31 of this embodiment includes the wiper arm 32 that reciprocally swings about the base end thereof, and the wiper blade 33 that is connected to a tip end of the wiper arm 32.

The wiper arm 32 has a distal end of the main lever 34 rotatably connected to a base end thereof. The wiper arm 32 also has a portion which is located closer to the tip end thereof than the joint of the wiper arm 32 and the main lever 34 is and to which a distal end of the sub-lever 35 is rotatably connected. The base end of the main lever 34 is connected to the drive shaft 22 of the wiper drive device 41, while the base end of the sub-lever 35 is connected to the follower shaft 23, which is integrally secured to the wiper drive device 41. A portion of the wiper arm 32, the main lever 34, and the sub-lever 35 which have connecting shafts extending in a direction substantially perpendicular to the wiping surface WSa and constitute the link mechanism 36. The tip end of the wiper arm 32 is connected to the wiper blade 33, which is arranged such that its blade rubber (not shown) is in contact with the wiping surface WSa.

When the main lever 34 is driven, the link mechanism 36 causes the wiper arm 32 to protrude away from the wiping surface WSa within a predetermined wiping range, in conjunction with its reciprocating swinging motion. As a result, when the main lever 34 is actuated, the wiper blade 33 performs a composite wiping operation on the wiping surface WSa, in which an additional outward flaring motion occurring at an intermediate portion of the basic arcuate motion is combined with the basic arcuate motion itself. In other words, the combination of the basic arcuate motion and the additional outward flaring motion of the wiper blade 33 enables the three-dimensional shape of the wiping area of the wiper blade 33 to conform to the three-dimensional shape of the wiping surface WSa for each vehicle type. For example, the wiping area can be expanded by bringing the wiper blade 33 as close as possible to a corner portion of the wiping surface WSa during the wiping operation.

### Wiper Drive Device 41

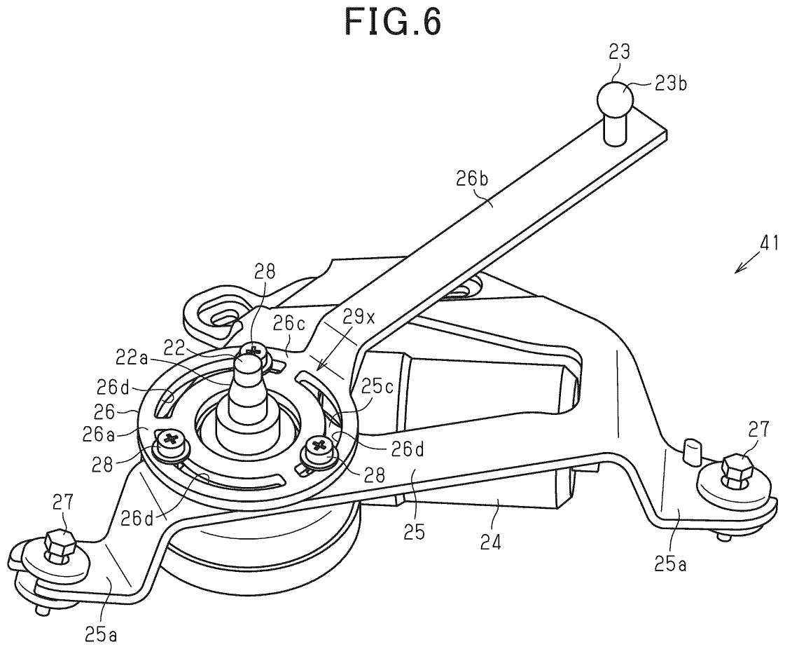

As shown in FIG. 6, the wiper drive device 41 of this embodiment has a shape that is slightly different from that of the first embodiment; however, it is substantially the same in terms of its functions. Therefore, in the wiper drive device 41, components having the same functions as those in the first embodiment are designated by the same reference numerals, and detailed descriptions thereof are omitted.

The wiper drive device 41 includes the electric wiper motor 24 having the drive shaft 22 for directly driving the main lever 34. The base end of the main lever 34 is integrally coupled with the mounting portion 22a at the distal end of the drive shaft 22. The wiper motor 24 is configured to reciprocally rotate the drive shaft 22 so as to reciprocally swing the main lever 34. The wiper drive device 41 further includes the mounting bracket 25 for fixing the wiper motor 24 to the vehicle body, and the shaft support plate 26 having the follower shaft 23 for supporting the sub-lever 35.

A major functional difference between the shaft support plate 26 of the second embodiment and that of the first embodiment lies in the fact that the follower shaft 23 is fixed. In the shaft support plate 26 of the second embodiment, the circumferential position of the follower shaft 23 relative to the drive shaft 22 may be adjusted by changing the mounting position of the shaft support plate 26 around the drive shaft 22 with respect to the mounting bracket 25. In other words, in the second embodiment as well, the shape of the wiping area of the wiper 31 can be easily set to a more suitable shape in accordance with the shape of the wiping surface WSa for each vehicle type.

### Beneficial Advantages Offered by the Second Embodiment

2-1

The vehicle wiper device 30 in this embodiment is designed to have the link mechanism 36 disposed between the wiper arm 32 and the drive shaft 22. The link mechanism 36 includes a drive member and a driven member which are implemented by the main lever 34 and the sub-lever 35, respectively. The circumferential position of the follower shaft 23, which supports the sub-lever 35, relative to the drive shaft 22 is changeable by the position changing mechanism 29x. In other words, the position of the follower shaft 23 is adjustable using the same mechanism, thereby allowing different wiping area shapes of the wiper 11 to be set with high accuracy. Accordingly, the same mechanism can be commonly used for multiple vehicle types.

2-2

In this embodiment, the same effects as those of the first embodiment can be obtained with respect to configurations similar to those of the first embodiment.

### Third Embodiment

The vehicle wiper device 50 according to the third embodiment will be described below.

### Vehicle Wiper Device 50

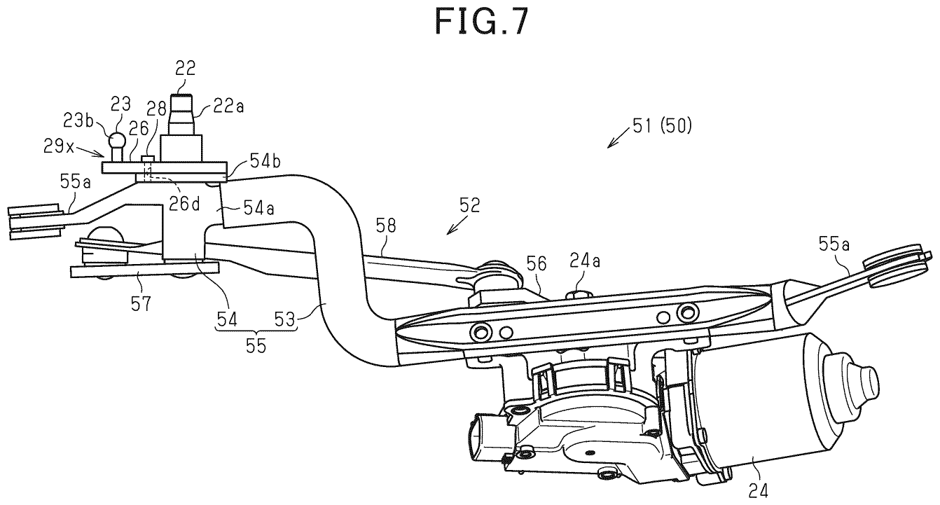

The vehicle wiper device 50 of the third embodiment differs from the first embodiment in the configuration of the wiper drive device 51, as shown in FIG. 7, while the same wiper 11 as that used in the first embodiment, shown in FIG. 1, is employed. Therefore, detailed descriptions and illustrations of the wiper 11 of this embodiment are omitted. In addition, for the wiper drive device 51 of this embodiment, components having the same functions as those in the first embodiment are designated by the same reference numerals, and detailed descriptions thereof are omitted.

### Wiper Drive Device 51

As shown in FIG. 7, the wiper drive device 51 of this embodiment is not directly driven by the wiper motor 24, but includes the swing mechanism 52 that converts a rotational motion of the wiper motor 24 into an oscillating motion. The wiper motor 24 may be made of an electrical motor designed to have a specification of unidirectional rotation may be used.

The wiper drive device 51 includes the fixing base 55, which serves as a mounting member to mount the wiper drive device 51 to the vehicle body. The fixing base 55 includes the pipe frame 53 and the shaft holder 54 which are coupled together. The fixing base 55 has vehicle body fixing portions 55a formed at appropriate positions on the pipe frame 53 and the shaft holder 54. The fixing base 55 is firmly secured to the vehicle body using the fixing portions 55a. The wiper motor 24 is secured to the pipe frame 53. The crank 56 is connected at a first end thereof to the distal end of the output shaft 24a of the wiper motor 24. The shaft holder 54 has the cylindrical portion 54a which retains the drive shaft 22 to be rotatable. The swing lever 57 has a first end firmly connected to the base end of the drive shaft 22. The second ends of the swing lever 57 and the crank 56 are connected to each other via the connecting link 58.

When the wiper motor 24 is driven, the crank 56 rotates in one direction together with the output shaft 24a. The rotation of the crank 56 in one direction causes the drive shaft 22 to reciprocally rotate through the connecting link 58 and the swing lever 57. The operation of the drive shaft 22 in this embodiment is the same as that in the first embodiment.

The shaft holder 54 includes, in addition to the cylindrical portion 54a that supports the drive shaft 22 by allowing the drive shaft 22 to be inserted therethrough, one of the vehicle body fixing portions 55a as a fastener to the vehicle body. The shaft holder 54 rotatably supports the drive shaft 22 and also holds the drive shaft 22 in a fixed position relative to the vehicle body.

In addition, the shaft holder 54 has, on an outer peripheral surface of the cylindrical portion 54a, the mounting portion 54b that is formed, for example, into a substantially flange shape. The shaft support plate 26, to which the follower shaft 23 is fixed, is mounted to the mounting portion 54b. The shaft support plate 26 of this embodiment is the same as that of the second embodiment, and a detailed illustration and description thereof are omitted. The circumferential position of the follower shaft 23 around the drive shaft 22 can be adjusted by changing the position of the shaft support plate 26 around the drive shaft 22 at which the shaft support plate 26 is secured to the mounting portion 54b of the shaft holder 54. This structure also facilitates matching the shape of the wiping area of the wiper 11 with the shape of the wiping surface WSa for each vehicle type.

### Beneficial Advantages Offered by the Third Embodiment

3-1 The vehicle wiper device 50 of the third embodiment is configured to have the swing mechanism 52 interposed between the wiper motor 24 and the drive shaft 22. The vehicle wiper device 50 of this embodiment offers substantially the same effects as those of the first and second embodiments with respect to configurations that are similar to those of the first and second embodiments.

### Modifications

The above-described embodiments may be modified in manners described below. The above embodiments and the following modifications may also be combined with each other as long as there is no technical inconsistency.

The circumferential and radial positions of the follower shaft 23, as defined in the circumferential and radial directions of the drive shaft 22, are, as described above, adjustable using the position changing mechanism 29x or 29y, respectively, but however, only one of the circumferential and radial positions may be adjustable. Specifically, as described in the second and third embodiments, only the circumferential position of the follower shaft 23 around the drive shaft 22 may be adjusted. Alternatively, only the radial position of the follower shaft 23 relative to the drive shaft 22 may be adjusted.

The position changing mechanisms 29x and 29y are, as described above, configured to include the elongated holes 26d and 26f, respectively. However, they may be modified, for example, by forming a plurality of position-adjusting holes in the shaft support plate 26. As described above, the interlocking portions serving as detent mechanisms are provided between the shaft support plate 26 and the mounting bracket 25, and between the follower shaft 23 and the shaft support plate 26. However, the interlocking portions may alternatively be provided only between the shaft support plate 26 and the mounting bracket 25, or only between the follower shaft 23 and the shaft support plate 26. Alternatively, the interlocking portions may be omitted altogether. In such a case, the shaft support plate 26 and the follower shaft 23 may be secured to each other using other types of fasteners that allow a greater number of mounting positions for the shaft support plate 26 and the follower shaft 23.

The joint between the follower shaft 23 and the shaft support plate 26 is achieved by fastening; however, they may alternatively be joined using a crimping technique. In addition to the above modification examples, the configuration of the vehicle wiper devices 10, 30, and 50 may be appropriately modified as necessary.

The expression “at least one,” as used in the present disclosure, means “one or more” of the designated options. For example, when two options are available, the expression “at least one” means either “only one of the two options” or “both of the two options.”

The technical concept that can be derived from the foregoing embodiments and modifications will be described below.

### First Structure

A vehicle wiper device (10, 30, 50) comprising: (a) a link mechanism (17, 36) which is configured to cause a wiper (11, 31) to perform a composite wiping operation including a combination of a basic arcuate motion and an additional motion; and (b) a position changing mechanism (29x, 29y). The link mechanism includes a drive member (14, 34) and a follower member (15, 35). The drive member is coupled with a drive shaft (22) which is driven in response to actuation of a wiper motor (24). The follower member is supported by a follower shaft (23) positioned relative to the drive shaft and configured to follow movement of the drive member. The follower shaft is coupled with a shaft support member (26) which is secured to a mounting member (25, 55) used to mount the vehicle wiper device to a vehicle body. The position changing mechanism is capable of changing at least one of a circumferential position and a radial position of the follower shaft relative to the drive shaft.

### Second Structure

The wiper drive device as set forth in the above-descried first structure, wherein the position changing mechanism (29x) is configured to change the circumferential position of the follower shaft relative to the drive shaft. The position changing mechanism may be provided by a mounting arrangement between the shaft support member and the mounting member.

### Third Structure

The wiper drive device as set forth in the above-described first or second structure, wherein the position changing mechanism (29y) is configured to change the radial position of the follower shaft relative to the drive shaft. The position changing mechanism may be provided by a mounting arrangement between the follower shaft and the shaft support member.

### Fourth Structure

The wiper drive device as set forth in the above-described second or third structure, wherein the position changing mechanism (29x, 29y) includes interlocking portions (25e, 26e, 26g) between the shaft support member and the mounting member or between the follower shaft and the shaft support member. The interlocking portions engaging with each other to place the shaft support member or the follower shaft at a selected one of a plurality of positions relative to the mounting member or the shaft support member.

### Fifth Structure

The wiper drive device as set forth in any one of the above-described second to fourth structures, wherein the position changing mechanism (29x, 29y) includes at least one elongated hole (26d, 26f) which allows coupling between the shaft support member and the mounting member, or between the follower shaft and the shaft support member, to be achieved at a selected one of a plurality of positions.

What is claimed is:

1. A vehicle wiper device comprising:
a link mechanism which is configured to cause a wiper to perform a composite wiping operation including a combination of a basic arcuate motion and an additional motion; and
a position changing mechanism, wherein
the link mechanism includes a drive member and a follower member, the drive member being coupled with a drive shaft which is driven in response to actuation of a wiper motor, the follower member being supported by a follower shaft positioned relative to the drive shaft and configured to follow movement of the drive member,
the follower shaft is coupled with a shaft support member which is secured to a mounting member used to mount the vehicle wiper device to a vehicle body, and
the position changing mechanism is capable of changing at least one of a circumferential position and a radial position of the follower shaft relative to the drive shaft.

2. The wiper drive device as set forth in claim 1, wherein the position changing mechanism is configured to change the circumferential position of the follower shaft relative to the drive shaft, and
the position changing mechanism is implemented by a mounting arrangement between the shaft support member and the mounting member.

3. The wiper drive device as set forth in claim 1, wherein the position changing mechanism is configured to change the radial position of the follower shaft relative to the drive shaft, and
the position changing mechanism is implemented by a mounting arrangement between the follower shaft and the shaft support member.

4. The wiper drive device as set forth in claim 2, wherein the position changing mechanism includes interlocking portions between the shaft support member and the mounting member or between the follower shaft and the shaft support member, the interlocking portions engaging with each other to place the shaft support member or the follower shaft at a selected one of a plurality of positions relative to the mounting member or the shaft support member.

5. The wiper drive device as set forth in claim 2, wherein the position changing mechanism includes an elongated hole(s) which allows coupling between the shaft support member and the mounting member, or between the follower shaft and the shaft support member, to be achieved at a selected one of a plurality of positions.

6. The wiper drive device as set forth in claim 3, wherein the position changing mechanism includes interlocking portions between the shaft support member and the mounting member or between the follower shaft and the shaft support member, the interlocking portions engaging with each other to place the shaft support member or the follower shaft at a selected one of a plurality of positions relative to the mounting member or the shaft support member.

7. The wiper drive device as set forth in claim 3, wherein the position changing mechanism includes an elongated hole(s) which allows coupling between the shaft support member and the mounting member, or between the follower shaft and the shaft support member, to be achieved at a selected one of a plurality of positions.
